(19) United States
(12) Patent Application Publication
(10) Pub. No.: US 2023/0215293 A1
(43) Pub. Date: Jul. 6, 2023

(54) SYSTEM AND METHOD FOR DESIGNING FOOD AND BEVERAGE FLAVOR EXPERIENCES

(71) Applicant: Spicerr Ltd., RaAnana (IL)

(72) Inventor: Tomer EDEN, Ometz (IL)

(73) Assignee: Spicerr Ltd., RaAnana (IL)

(21) Appl. No.: 17/927,918

(22) PCT Filed: May 28, 2021
(86) PCT No.: PCT/IB2021/054716

§ 371 Date: Nov. 28, 2022

Related U.S. Application Data
(60) Provisional application No. 63/031,345, filed on May 28, 2020.

(51) Int. Cl. G09B 19/00

(52) U.S. Cl. CPC G09B 19/0092

(57) ABSTRACT

A system and method for designing food and beverage flavor experiences are provided. The method includes analyzing collected user experience data and collected flavor profile and recipe data; determining flavoring information and flavoring adjustments based on the analysis; and synchronizing the determined flavoring information and flavoring adjustments.

### CROSS-REFERENCE TO RELATED APPLICATIONS

This application claims the benefit of U.S. Provisional Application No. 63/031,345 filed on May 28, 2020, the contents of which are hereby incorporated by reference.

### TECHNICAL FIELD

The present disclosure relates generally to food and beverage flavoring and, in particular, to systems and methods for analyzing and designing food and beverage flavor experiences.

### BACKGROUND

The culinary arts, concerning eating and drinking experiences, involve measures of both personal preference and objective determinations. Many diners enjoy the experience of a well-prepared meal, and often make or request special changes to dishes to suit their individual preferences. As tastes and preferences may be subjective, a change which one diner enjoys might be detested by others. Further, as the flavor of a food or beverage often depends on the accurate measurement of ingredients, recipe modifications which include subtle differences may create entirely new tastes and flavors. Although culinary skill is a prized talent, advances in the arts and sciences of flavor and taste are often delayed by a desire to accommodate the preferences and tastes of a broad range of individuals. Further, although technology has advanced significantly in a short time, advanced technologies are not widely-employed to create quality flavor experiences.

The preferences of individual diners may be difficult for chefs to accommodate due to the range of preferences which individuals may have. Although tastes vary from person to person, certain flavors may be wildly popular in various cultures or geographies, and may be equally unpopular in others. These differences in preference contribute to the popularity of certain fusion cuisines and allow cooks to explore previously-unknown flavor combinations. The collection of flavor preferences from a variety of individuals may allow for a more robust and responsive flavoring experience. However, systems to aggregate personal preference and, using the aggregated preference, develop flavor experiences, are not widely deployed.

Further, while the qualities of certain ingredients are well-understood, the precise chemical and molecular nature of these qualities remains somewhat mysterious to the average home or restaurant chef. Although large-scale producers may incorporate food science in designing their products, home and small-scale chefs may be unable to access and apply the relevant chemical information. While chemical and molecular flavor data is available, current methods for applying this information to create tailored flavor experiences, particularly methods leveraging recent technological advances, remain inaccessible to home and restaurant cooks.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the terms “some embodiments” or “certain embodiments” may be used herein to refer to a single embodiment or multiple embodiments of the disclosure.

Certain embodiments disclosed herein include a method for designing food and beverage flavor experiences. The method comprises: analyzing collected user experience data and collected flavor profile and recipe data; determining flavoring information and flavoring adjustments based on the analysis; and synchronizing the determined flavoring information and flavoring adjustments.

Certain embodiments disclosed herein also include a non-transitory computer readable medium having stored thereon instructions for causing a processing circuitry to execute a process, the process comprising: analyzing collected user experience data and collected flavor profile and recipe data; determining flavoring information and flavoring adjustments based on the analysis; and synchronizing the determined flavoring information and flavoring adjustments.

In addition, certain embodiments disclosed herein include a system for designing food and beverage flavor experiences. The system comprises: a processing circuitry; and a memory, the memory containing instructions that, when executed by the processing circuitry, configure the system to: analyze collected user experience data and collected flavor profile and recipe data; determine flavoring information and flavoring adjustments based on the analysis; and synchronize the determined flavoring information and flavoring adjustments.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a right-isometric view of a dispenser device, according to an embodiment.

FIG. 2 is a block diagram depicting a system for designing food and beverage flavor experiences, according to an embodiment.

FIG. 3 is a flowchart depicting a method for designing food and beverage flavor experiences, according to an embodiment.

FIG. 4A is an illustration depicting a flavor molecule classification table, utilized to describe flavoring information according to various embodiments.

FIG. 4B is an illustration depicting a flavor profile, according to an embodiment.

FIG. 5 is a schematic diagram of an analytic engine, which may be included in a system for designing food and beverage flavor experiences, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for designing food and beverage flavor experiences. As human preference may vary between individuals, and as a variety of factors influence the flavor of a food or beverage, creation of recipes with broad or tailored appeal may be possible by analysis of large amounts of data. The disclosed system and method address the need for such an analysis of taste and flavor information, providing a combination of AI, science, and culinary knowledge to create optimized culinary experiences and tailor tastes and flavors to users' personal preferences. A flavor may include or refer to taste, scent, texture, or temperature.

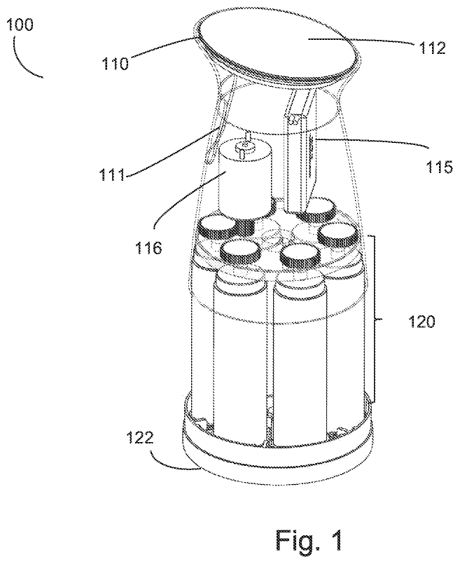

FIG. 1 is a right-isometric view of a dispenser device 100, according to an embodiment. Note that some components are hidden to show internal structures. In the example embodiment, the dispenser device includes an axis, a device head 110, a capsule magazine 120, and a plurality of capsules 130. The dispenser device 100 described herein is an example of a dispenser device, as may be considered in greater detail with respect to the co-pending U.S. application Ser. No. 17/308,628, of the common inventor, the contents of which are hereby incorporated by reference. The dispenser device 100 described herein is provided and described for illustrative purposes, to provide a greater understanding as to the operation of the system and method described, with respect to such dispenser devices 100.

The dispenser device head 110 may include a display 112, a trigger 111, a battery 115, a motor 116, and a gear 117. In the example embodiment, the display 112 may be configured to show information related to device status and dispenser operations including, without limitation, remaining battery life, the “active” capsule, relevant spicing profiles, the amount of spice to be dispensed, and the like. In an embodiment, the dispenser device head 110 may include a sensor configured to read a code attached to each capsule to determine the capsules' contents by communication protocols including, without limitation, near-field connection (NFC), radio-frequency identification (RFID), quick response (QR) code(r), barcode, and the like.

In the example embodiment, the trigger 111 may be configured as a switch, controlling the flow of electrical power from the battery 115 to the motor 116. The flow of electrical power from the battery 115 to the motor 116 may cause the motor 116 to turn a connecting member 118. In the rotation of the connecting member 118, extending from the motor 116 in the device head 110 to the gear 117, which substantially contacts a toothed gear element 137 near the top of the capsule 130, the attached gear 117 is made to rotate, thereby causing the “active” capsule 121 to rotate by engaging the toothed gear element 137 near the top of the capsule 130.

In the example embodiment, the capsule magazine 120 contains a plurality of capsules 130 and a charging stand 122. It may be understood that the dispenser device 100 depicted includes capsules 130 for purposes of explanation and that, in an alternate embodiment, the dispenser device 100 may include flavor-containing elements other than capsules, such as loose spices, whole ingredients such as ginger root, and the like. One capsule at a time is the “active” capsule 121, selected for dispensation. The capsule magazine 120 may be configured to rotate about the axis of the device, allowing the user to select an “active” capsule 121 containing a material 131 for dispensation. In an embodiment, the user may select the “active” capsule 121 by, as examples and, without limitation, manual rotation of the capsule magazine 120, selection of capsules 130 through device displays and controls, selection of capsules through external devices such as smartphones, and the like.

In an embodiment, the capsule magazine includes a charging stand 122 affixed to the base of the capsule magazine 120. The charging stand 122 may be configured to, in conjunction with an external power supply, recharge the battery 115. In addition, the external power supply may be, without limitation, an AC adapter, a wireless charging station, an induction charging station, and the like.

In an embodiment, the capsule includes a contained material, a pusher, a pushing element, a dispensing element, and an end cap. In an embodiment, the dispensing element may include, without limitation, scrapers, pumps, and the like, configured to dispense material in controlled amounts depending on the rotation of the capsule.

In an embodiment, the dispensing element may be a scraper, configured such that rotation of the capsule turns the contained material, pushing the material against the scraper's blade, scraping loose an amount of material for dispensation through an aperture in the dispensing element.

In an embodiment, the dispensing element may be a pump, configured such that rotation of the capsule in a first direction turns a set of wheels over a flexible barrier, creating pockets of material within the barrier, which further rotation of the capsule pushes toward the aperture of the dispensing element for dispensation. In an embodiment, the pump may be configured such that rotation of the capsule in a second direction, opposite the first direction, causes liquid remaining in the flexible barrier to return to the capsule 130 for stable storage.

In an embodiment, each capsule may be configured to engage with the gear via a toothed gear mechanism disposed near the top of the capsule. In an embodiment, the capsule's engagement with the gear may render the capsule rotatable via the motor 116, allowing a user to control the rotation of capsules and, thus, the dispensation of materials, via the trigger 111.

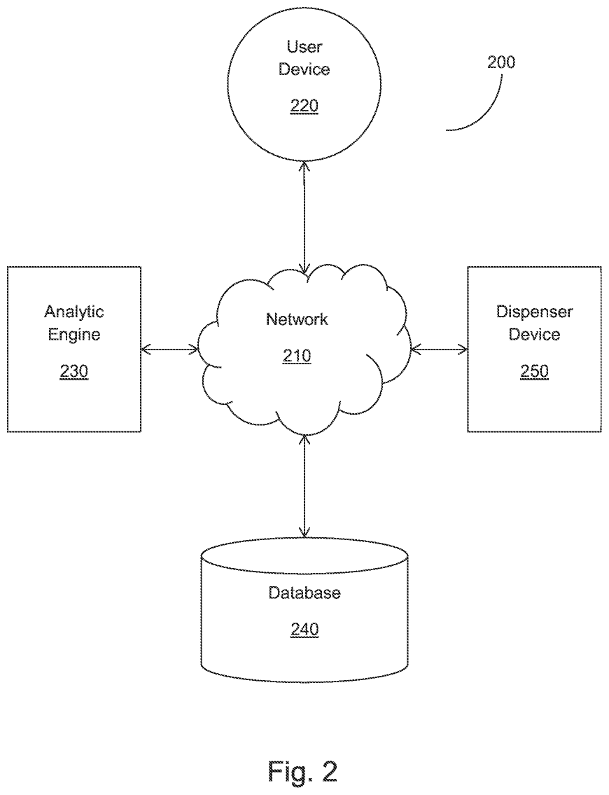

FIG. 2 is a block diagram depicting a system 200 for designing food and beverage flavor experiences, according to an embodiment. The system depicted includes a network 210, a user device 220, an analytic engine 230, a database, 240, and a dispenser device 250. Although the system 200 depicted includes one of each component, the system 200 may include multiples of one or more of the components depicted without loss of generality or departure from the scope of the disclosure. Further, as described in detail below, certain components included in the system 200 as depicted may be omitted from other embodiments without loss of generality or departure from the scope of the disclosed.

The system 200 includes a network 210. The network 210 may be configured to connect one or more components of the system 200. The network 210 may be the Internet, the world-wide-web (WWW), a local area network (LAN), a wide area network (WAN), a metro area network (MAN), or another network capable of enabling communication between elements of the system 200. The network 210 may connect with the various components of the system 200 by wired connections including, without limitation, ethernet, USB, other, like, connections, and any combination thereof, by wireless connections including, without limitation, Wi-Fi, Bluetooth®, other, like, wireless connections, and any combination thereof, as well as any combination of wired and wireless connections. The network 210 may be implemented as a full-physical network, wherein all of the included components are implemented as physical devices, as a virtual network, wherein the included components are simulated or otherwise virtualized, or as a hybrid physical-virtual network including some physical and some virtual components. Further, the network 210 may be configured to encrypt data, both at rest and in motion, and to allow the transmission and receipt of encrypted, partially-encrypted, and unencrypted data.

The user device 220 is a device providing for a user to interface with one or more components of the system 200. The user device 220 may be a smart phone, tablet, personal computer, dedicated terminal, 3^{rd} party system or terminal or kiosk, or other, like, device configured to provide a user with an interface to one or more components of the system 200. The user device 220 may include one or more elements or components configured to provide a user with input and output access to the user device 220 including, without limitation, a keyboard, a mouse, a touchscreen, a trackpad, a display screen, a speaker, other, like, elements or components, or any combination thereof. Although one user device 220 is included in the system 200 depicted, for the sake of simplicity, multiple user devices 220 may be included in the system 200 without loss of generality or departure from the scope of the disclosed. The user device 220 may be configured to connect directly with other components of the system 200, without the network 210, including, without limitation, the dispenser device 250, by wired connections, wireless connections, or any combination of wired and wireless connections.

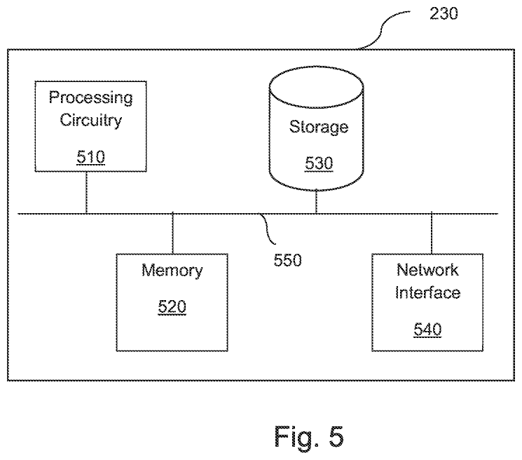

The analytic engine 230 is a device configured to execute one or more tasks including, without limitation, analysis, processing, and the like. The analytic engine 230 may be a computer, computer system, remote server, cloud computing system, or other, like, system for processing data. The analytic engine 230 may be a physical system, a virtualized or otherwise simulated system, or a hybrid system, including both physical and virtual elements. In an embodiment, the analytic engine 230 may be configured to connect directly with other components of the system including, without limitation, the analytic database 240, without the network 210. The analytic engine 230 may include, in an embodiment, the components depicted and described with respect to FIG. 5, below.

The analytic engine 230 may be configured to generate flavor experience insights or predictions. Flavor experience insights are aggregate data analyses describing the culinary preferences of individual users, groups of users, or all users. Flavor experience insights may include aggregate flavor data analyses applicable to parties including, without limitation, food and beverage manufacturers and distributors, restaurants, recipe writers, and other, like, parties. Flavor experience insights may be generated from any or all data sources described herein including, without limitation, detailed and personal usage data collected from users of the disclosed system and method. In an embodiment, flavor experience insights may include anonymized, obfuscated, or otherwise de-identified user data.

The analytic engine 230 may be configured to generate flavor experience insights by assessing potential audiences for specific flavors or combinations of flavors, specific combinations of ingredients, specific combinations of ingredients and flavors, specific food products, and other, like, flavor experiences. The analytic engine 230 may be further configured to generate flavor experience insights directed to tracking new trends relating to the acceptance of ingredients and flavors, as well as the potential audiences for such trends. In addition, the analytic engine 230 may be configured to generate flavor experience insights directed to targeting food products to relevant audience groups. The analytic engine 230 may be configured to generate flavor experience insights describing the preferences of groups of users, wherein the groups of users are defined by parameters including, without limitation, geography, age, culinary preferences, other, like, parameters, and any combination thereof.

A first example of generating flavor experience insights may include generating an insight specifying that, based on collected usage data, in the last financial quarter, users in a specific age group and location are using twelve percent more basil in home cooking, specifically in tomato-sauce pasta. A second example may include generating an insight specifying that, based on usage data and flavor analysis, consumers in a specific location prefer green tea and ginger and, therefore, might enjoy a new type of green tea with a ginger and turmeric root flavor. A third example of generating a flavor experience insight may include generating an insight specifying that, based on usage data and flavor molecule analysis, the most relevant audience for a new ice cream product is women of a certain age group who live in a specified city.

The database 240 is an information storage and access component configured to provide data warehousing and associated functions to the various components included in the network 210. The database 240 may be a local or remote data storage device, a cloud storage system, another, like, device, and any combination thereof. The database 240 may be configured to encrypt data, both at rest and in motion, and to both send and receive encrypted, partially-encrypted, or unencrypted data. The database may be configured to provide data management functionality to one or more components of the system 200. Data management functionality may include functions for sending and receiving data, functions for monitoring the contents of the database 240, other, like, functions, and any combination thereof.

The dispenser device 250 may be a device configured to provide one or more food or beverage flavors. The dispenser device 250 may include foods, ingredients, flavor extracts, or other, like, reagents affecting the flavor of a food or beverage. The dispenser device may include various motors, gears, axles, and other, like, components configurable for the dispensation of flavor reagents. Further, the dispenser device 250 may include electronic processing, actuation, and networking components configurable to provide enhanced flavor experiences in conjunction with the system and method disclosed herein. The dispenser device, in an embodiment, is depicted and described with respect to FIG. 1, above.

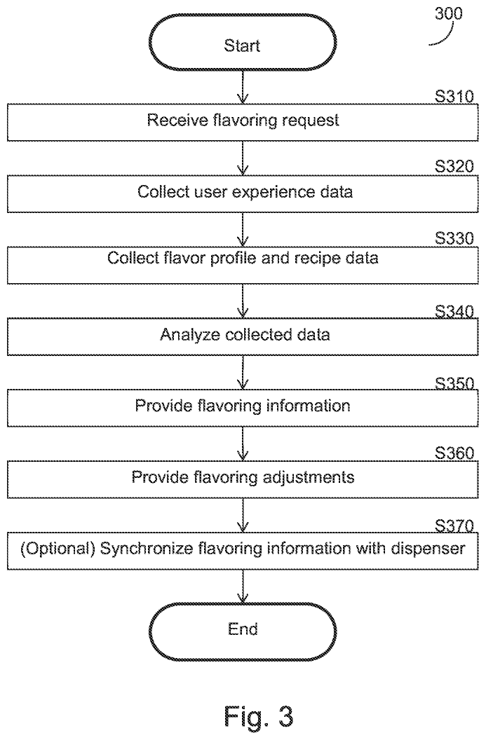

FIG. 3 is an example flowchart 300 depicting a method for designing food and beverage flavor experiences, according to an embodiment. The method depicted in the flowchart 300 is directed to the collection and analysis of food, flavor, and user preference data, and the application of the analysis to designing food and beverage flavor experience, including by synchronization with dispenser devices, such as the dispenser device, 250, of FIG. 2, above. The method depicted in the flowchart includes the receipt of a flavoring request, the collection of user experience data and flavor profile and recipe data, the analysis of the collected data, the provision of flavoring information and adjustments, and synchronization with a dispenser device. The various steps depicted may be appreciated with respect to the following description.

At S310, a flavoring request is received. A flavoring request may be a request specifying a given flavor, ingredient, food, dish, recipe, or the like. A flavoring request may further indicate a flavoring request type. A flavoring request type indication may describe the flavoring information and experience enhancements a user wishes to receive. Examples of flavoring request types may include requests for recipes having a given flavor, requests for dishes containing a specific ingredient, requests for ingredient substitutes, requests for food and beverage pairing suggestions, other, like, requests, and any combination thereof. A flavoring request may be received from a user device, including the user device, 220, of FIG. 2, above.

At S320, user experience data is collected. User experience data may include data describing a user, a user's culinary preferences, a user's cooking and dining habits, a user's location, and other, like, factors. User experience data may be collected from one or more sources including, without limitation a user device, such as the user device, 220, of FIG. 2, above, a dispenser device, such as the dispenser device, 250, of FIG. 2, above, and other, like, sources.

User experience data, as collected at S320, may include a user's personal data. A user's personal data may include information describing a user's personal culinary preferences, nutritional preferences, other, like, information, and any combination thereof. A user's personal data, as may be collected at S320, may be associated with a single user or with a user group, such as a couple, a family, and the like. User personal data may be set manually by a user or may be learned by a flavor management system or device through various learning processes.

User experience data collected at S320 may include user-specific taste and preference data which may be applicable to subsequent analysis, including analysis at S340. User experience data collected at S320 may include ingredient preferences, flavor preferences, flavor intensity preferences, ingredient ratio preferences, parameter combination preferences, and other, like, information. Ingredient preferences may describe the ingredients which a user enjoys, the ingredients which a user dislikes, and ingredients toward which a user has no opinion or which the user has never tried. Flavor preferences may describe flavors which a user enjoys, flavors which a user dislikes, and flavors toward which a user has no opinion or which the user has never tried. Flavor intensity preferences may describe a user's preferences for various flavors. An example of flavor intensity preference data may be datapoints indicating that a user prefers desserts with sweetness levels of four or above, or that a user prefers soups with spiciness levels of two or below. Ingredient ratio preferences may describe a user's preferences for combinations of two or more ingredients. An example of ingredient ratio preferences may be datapoints indicating that a user prefers basil used in a ratio of 2% or lower, or that a user prefers a ratio of 1:2 or higher for combinations of salt and black pepper. Parameter combination preferences may describe compound preferences relating to ingredient preferences, flavor preferences, flavor intensity preferences, ingredient ratio preferences, and the like. Examples of parameter combination preferences may include data indicating that a user enjoys dishes with spiciness levels of three or higher when the dish includes a ratio of mushrooms in the dish of 10% or more, or when the dish includes potatoes.

User experience data, as collected at S320, may include aggregated data concerning user preferences and flavoring habits. User preferences and flavoring habits may include data such as, as examples and without limitation, dispenser usage data, users' personal data, other, like, information, and any combination thereof. Further, collection of user experience data at S320 may include collection of recipe-related user data including, without limitation, aggregate recipe popularity, as determined by analysis of data collected from one or more users, rankings and reviews of flavors, ingredients, food, and recipes, as may be collected from users, individual users' personal preferences, other, like, information, and any combination thereof.

Collection of user flavor experience data at S320 may include the collection of one or more survey responses. Survey responses may be generated in response to one or more surveys concerning user culinary habits and food item preferences. Surveys may include requests for user preference ratings regarding foods and related elements including, without limitation, food ingredients, food products, specific flavors, specific scents, combinations of ingredients, other, like, flavor-related factors, and any combination thereof. A survey may include one or more questions, wherein each question may include one or more sub-questions such as, as examples and without limitation, “do you like the food item,” “what flavors and scents do you feel in this food item,” and “what are the intensity of flavors and scents in the food item?” A survey may include one or more questions designed based on the results of a clustering and profiling process, wherein questions are selected based on the questions' ability to effectively classify users into groups.

A survey may be sent to a user by channels including, without limitation, electronic communication, postal mail, telephone, and other, like, channels. Survey responses may be collected by channels similar or identical to those used to transmit surveys to users. Surveys and survey responses may be sent and collected according to various timing schemes including, without limitation, random surveying, periodic surveying, such as twice a year, one-time surveying, such as when a user initially accesses a flavor management system or device, or according to other, like, timing schemes. Further, surveys and responses may be transmitted and collected based on the occurrence of food or flavor-based events such as, as examples and without limitation, a user's visit to a new restaurant, a user's consumption of a new food or beverage, a user's return from a foreign country or region, and other, like, food or flavor-based events. In addition, surveys and results may be transmitted and collected at the user's request to provide updated preference and tasting information.

In an embodiment, collection of user flavor experience data at S320 may include collecting the results of one or more taste kits. A taste kit is a sample testing kit providing, for user sampling, various flavors, scents, textures, and combinations thereof. The taste kit may include various foods, beverages, and scents, and the like, in addition to a survey or questionnaire concerning a user's responses to the samples included in the taste kit. For example, the survey or questionnaire included in the taste kit may include questions such as “did you like the taste and scent of sample 17?” and “what is the level of bitterness of this sample, on a scale of one to five?” The included survey or questionnaire may be a virtual survey or questionnaire, such as, as examples and without limitation, a web-accessible survey or questionnaire, a survey or questionnaire included in an application installed on a user device, such as the user device, 220, of FIG. 2, above, and other, like, virtual surveys or questionnaires. In addition, the survey or questionnaire may be a paper form included in the taste kit, which the user may submit by mail for taste kit preference analysis. Further, the survey or questionnaire may be an audio survey or questionnaire, by which the user may submit their taste kit responses and preference by telephone or the like.

The taste kit may include sample foods, ingredients, flavors, and the like, which may be pre-selected to provide for profiling and grouping of users. Where the samples included in the taste kit are pre-selected to provide for profiling and grouping, the samples included in the test kit may include foods, flavors, ingredients, and the like which are known to be effective for the classification of users into groups. As an example, a taste kit including samples pre-selected for user profiling and grouping may include a sample blend combining mushrooms with fruits, the fruits having a “sweetness” rating of four, where the sample blend is pre-selected to determine, based on a user's response, whether to include the user in a specific culinary preference group for taste analysis and flavor experience suggestion.

Collecting user experience data at S320 may include collecting usage data. Usage data may be data describing users' culinary activities and preferences, data generated based on user interactions with a dispenser device, such as the dispenser device, 250, of FIG. 2, above, or data describing users' culinary activities and preferences based on interactions with a dispenser device, such as the dispenser device, 250, of FIG. 2, above. Usage data may include data such as, as examples, and without limitation, which capsules or flavor-containing elements a user orders for use with a dispenser device, such as the dispenser device, 250, of FIG. 2, above and a user's usage patterns for various capsules or flavor-containing elements. Usage data may also include data pertaining to users' flavor perceptions, rankings, and reviews of various capsules or flavor-containing elements, ingredients, recipes, and flavor experience recommendations or suggestions, as are described in detail with respect to S360, below. In addition, usage data may include data describing which food ingredients, food products, or recipes users like or dislike, regardless of whether one or more capsules or flavor-containing elements are combined. As an example, usage data, describing which food ingredients, food products, or recipes users like or dislike, regardless of whether one or more capsules or flavor-containing elements are combined, may include data indicating which types of recipes a user prefers and data indicating which ice cream flavor a user enjoys. Further, usage data may include data pertinent to sharing a user's preferences with other users including, without limitation, suggestions for capsules or flavor-containing elements, recipes, reviews, other, like, information, and any combination thereof.

In addition to those forms of usage data described above, usage data, as may be included in user experience data collected at S330, may include data related to which capsules or flavor-containing elements one or more users are using, and the quantities with which users combine ingredients, recipes, ingredients, and the like. Where capsule or flavor-containing element data, and related quantity and combination data, is included in user experience data collected at S330, the collected capsule or flavor-containing element data, and relevant quantity and combination data, may relate to various circumstances in which users combine capsules, or flavor containing elements, or combine the contents thereof with various food ingredients or food products. Relevant circumstances may include those circumstances wherein users combine capsules or flavor-containing elements, circumstances wherein users follow recipe directions, circumstances wherein users follow suggested or recommended recipes with instructions different from the recipes'standard directions, circumstances in which users change the directions of a recipe or suggested recipe variant. In addition, relevant circumstances may include those circumstances in which a user combines capsules, or flavor-containing elements, including with other foods or food products, in a “free-style” or unguided pattern and provides additional usage data, such as, as an example, when a user applies a specific set of capsules or flavor-containing elements and, subsequently, labels the set “mushroom soup.” Further, relevant circumstances may include other circumstances like those described above, as well as any combination thereof.

Collecting user experience data at S320 may include collecting taste data, including information indicating users' perceptions of the flavors of various ingredients, combinations of ingredients, food products, recipes, and the like. Collecting taste data may include collecting user feedback regarding the various flavors in an ingredient, dish, or recipe, as well as the associated intensity of each. Taste data may include overall rankings provided by users. Examples of overall rankings collected, as part of a taste data set, at S330, include data indicating that a user regards the bitterness level of a recipe as four out of ten and data indicating that a user regards the flavor of a given vanilla capsule, or flavor-containing element, as having a sweetness of three out of ten, a bitterness of one out of ten, an orange flavor intensity of three out of ten, and a creaminess of seven out of ten. Additional examples of taste data include data indicating that a user perceives a yogurt as having no taste of fat and data indicating that a user has given a specific paprika an overall rating of eight out of ten.

Taste data, as may be included in user experience data collected at S320, may be collected from sources including, without limitation, taste groups, users, social networks, online websites, external services, other, like, sources, and any combination thereof. Taste groups may be testing or focus groups wherein testers are asked to sample different food items and provide opinions or feedback. User sources for taste data may include opinions provided by users connected with one or more of the systems or methods described herein. Social network, online website, and external service sources may include opinions published online concerning capsules or flavor-containing elements, food ingredients, food products, recipes, and the like.

At S330, flavor profile and recipe data is collected. Flavor profile and recipe data may be data describing the flavor, ingredients, known attributes, preparation methods, and other, like, characteristics of a given flavor, ingredient, food, dish, recipe, or other, like, flavor experience. Flavor profile and recipe data may be drawn from a variety of sources including, without limitation, scientific journals, industry publications, cookbooks, online sources such as blogs, databases, and the like, and other, like sources. Flavor profile and recipe data may be collected directly from the primary sources identified above, may be pre-collected and archived in a data store, such as the database, 240, of FIG. 2, above, or may be collected from both primary sources and data stores.

Collection of flavor profile and recipe data at S330 may include collecting data suitable for subsequent analysis, such as by the analyses described with respect to S340, below. Collection of flavor profile and recipe data at S330 may include collection and aggregation of data from multiple sources such as, as examples and without limitation, recipes, taste and flavor data, food and ingredient chemical structures, rules set by culinary experts or other trusted sources of culinary information, nutritional information, other, like, sources, and any combination thereof. Further, collection of flavor profile and recipe data at S330 may include recipe-specific data collected from recipes and other sources of information providing users with information regarding how to cook or bake. Recipe-specific data may include, as examples and without limitation, a general title and description of a food, dish, or ingredient, such as “sweet potatoes,” dish ingredients and spices, quantities of each ingredient, cooking, baking, and preparation methods, timing and sequencing information for each ingredient, relevant geographic origins of a recipe, classifications of a recipe, such as “Thai rice,” other, like, information, and any combination thereof.

Collection of flavor profiles and recipe data at S330 may include collection of one or more flavoring rules. Flavoring rules are rules determined and set by one or more flavoring experts. Flavoring rules may include, as examples and without limitation, rules for combining flavors and ingredients, rules specifying desirable combinations, and rules specifying undesirable combinations. Flavoring rules may further include ingredient rules and flavor rules. Ingredient rules may be rules specifying the selection and combination of ingredients, such as, as an example, a rule specifying that onions, mushrooms, and pasta are well-combined and should be combined in a ratio of 5:8:100. Flavor rules may be rules specifying the selection and combination of flavors such as, as an example, a rule specifying that sweet, bitter, and fruity flavors are well-combined and should be combined in an intensity ratio of 5:3:2.

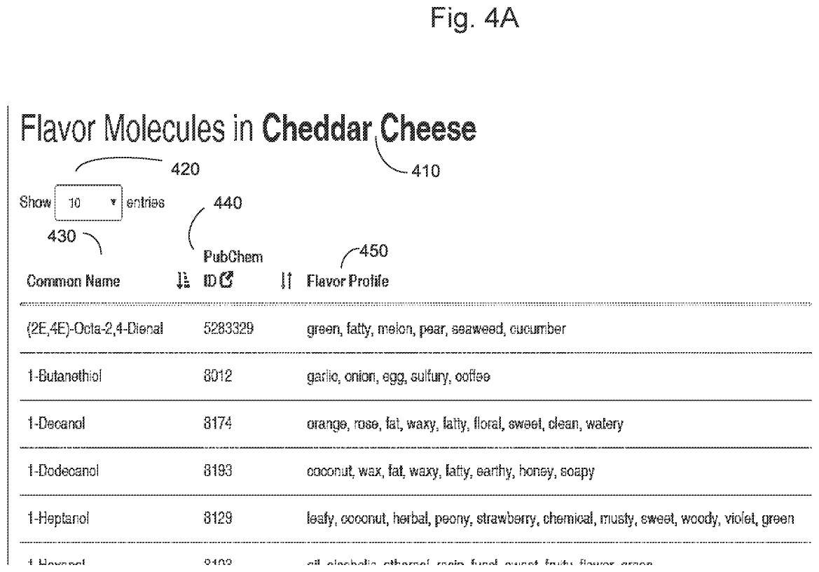

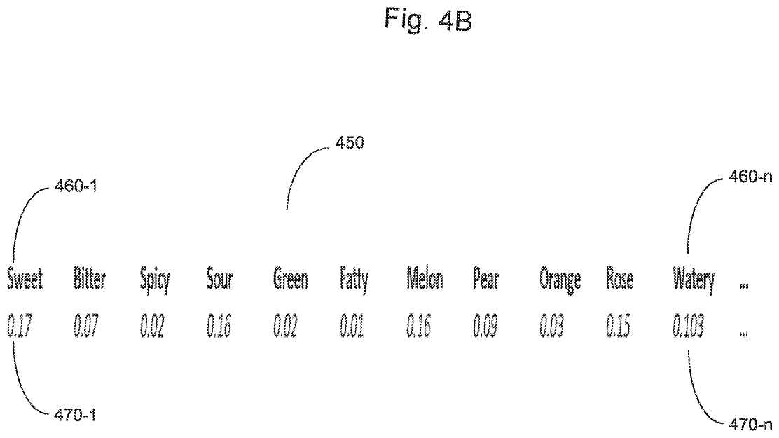

Collection of flavor profiles and recipe data at S330 may include collection of chemical or molecular information related to food products, ingredients, recipes, and the like. Collection of chemical or molecular information, as at S330, may include collection of chemical or molecular data regarding aspects of food or flavor, including, without limitation, flavor molecules and lists of associated flavors, nutritional information, such as caloric, fat, and protein contents, and the like, chemical structures, molecular structures, and other, like, information. Chemical and molecular information, and associated applications, are described in greater detail with respect to FIGS. 4A and 4B, below.

It may be noted that steps S320 and S330 may occur in any order, including simultaneously, without loss of generality or departure from the scope of the disclosed.

At S340, data collected at steps S320 and S330 is analyzed. The analysis of data at S340 may provide for the organization, simplification, or other manipulation of the data collected previously. Further, analysis at S340 may include the classification of flavors, ingredients, foods, dishes, recipes and the like, the generation and revision of learning algorithms and other dynamic methods of data analysis, the generation of personalized suggestions, and other, like, tasks.

Analysis at S340 may include the classification of culinary examples. Classification of culinary examples at S340 may include the training of one or more artificial intelligence or deep learning systems. Classification of culinary examples may include the classification of examples into “positive” and “negative or “good” and “bad” classes based on users' perceptions and the sensorial result of the given examples. Culinary examples may be recipes collected from external sources, such as recipe sites, or recipes or combinations generated according to the processes described herein. Examples may be classified according to factors including, without limitation, community reviews describing reviews and scores generated by different users in response to examination or testing of an example, reviews from taste groups including users tasting the examples, usage data, as may be collected at S320, information reflecting how users reacted to, or have used the culinary samples, other, like, information, and any combination thereof. Information reflecting how users reacted to, or have used, the culinary samples may include descriptions of, without limitation, users who have reviewed information relating to an example and the length of the users' reviews, users who have saved the examples, users who have implemented the examples, as well as whether the implementing users have modified the examples, users who have implemented the examples a second time, users who have suggested the example to others, data regarding the users, such as country of origin, culinary preferences, and the like, other, like, descriptions, and any combination thereof.

Where analysis at S340 includes classification of culinary examples, analysis at S340 may include identification of patterns describing examples which are positively and negatively received, and classification of the examples accordingly. A given example may be classified according to a general classification and may be separately classified for a group of users, e.g., a recipe may be classified as “good” for users in the United States and classified as “bad” for users in Brazil.

In addition, analysis at S340 may include detection of flavor or ingredient patterns. Where analysis at S340 includes detection of flavor or ingredient patterns, aggregated data, collected at S320 and S330, may be analyzed to determine the existence of patterns indicating how food products, food ingredients, flavors and molecules are combined to create proper synergy. Detection of flavor or ingredient patterns may include analysis of information regarding how various flavor or ingredient patterns are appreciated by tasters or users from different groups, including those groups defined by the clustering processes discussed in greater detail hereinbelow.

Where analysis at S340 includes detection of flavor or ingredient patterns, a learning process may be applied to the identification or detection of flavor or ingredient patterns. A learning process may include, at the outset, the creation of records for all examples, including recipes, ingredients, combinations, and the like, including various relevant information. Information relevant to the creation of records for a learning process may include, without limitation, general information, such as descriptions of geographic origins or relevant cuisines, descriptions of a recipe's calculated flavors, aggregations of ingredients' chemical structures, calculated flavors, perceived flavors, and nutritional values, engineered features for a recipe, such as flavor ratios and chemical structure relationships, overall community rankings and popularity levels, describing the number of people who tried and enjoyed a flavor experience, and source reliability information, describing the reliability of each source for each example. Further, information relevant to the creation of records for a learning process may include lists of ingredients and various related information including, without limitation, names of ingredients, quantities, preparation methods, such as cooking or baking, chemical structures, calculated flavors from flavor molecules, perceived flavors from taste groups, nutrition values, engineered features, such as flavor ratios and chemical structure relationships, and other, like, information. Information relevant to the creation of records for a learning process may include additional information similar to that described above, as well as any combination thereof.

Where analysis at S340 includes detection of flavor or ingredient patterns, the information included in the records created, as described previously, may be analyzed and tracked to detect patterns involving the contents of one or more of the records described, where the patterns may indicate positive and negative flavor experience results. For example, a detected flavor or ingredient pattern may relate to information describing, for Spanish-style cooking, a preferred ratio of bitter, waxy, and sweet flavors when a dish includes potatoes, and the same ratio when a dish includes tomatoes.

Further, where analysis at S340 includes detection of flavor or ingredient patterns, a score may be assigned to each pattern learned. The assigned score may be derived from the number of examples included in the relevant pattern, community rankings associated with the examples included in the relevant pattern, and the reliability of the sources. A first example of a pattern which may be learned may be a pattern indicating a good combination, as indicated due to high community rankings, related to, in Asian recipes, a combination of mushrooms with ingredients having molecules “X,” and “Y,” provided that ingredients with a bitterness level of four or above and ingredients with fat levels below five percent are not included in the combination. A second example of a pattern which may be learned may be a pattern indicating a good combination, as specified by an identified reliable source, including, for users in Italy, a combination of red vegetables having bitterness levels of five percent or above with ground black or yellow spices having sweetness levels of one to two, provided that the ratio between the vegetables and the spices is between twelve to one and nine to one, or twelve to nine grams of vegetable per gram of spice. A third example of a pattern which may be learned may be a pattern indicating a good recipe for recipes wherein the aggregated flavor profile ratio of woodiness to bitterness to sweetness is one to twenty to four, and wherein the total fat level is between five and seven percent.

Analysis at S340 may include analysis and calculation of ingredient and flavor ratios for combinations of two or more ingredients, flavors, foods, and the like. Ratio analysis may include the generation of statistical measures including, without limitation, averages, medians, standard deviations, and the like. Ratios may be calculated based on data including, without limitation, data from recipes, rules specified by experts, collected usage data, other, like, data, and any combination thereof. Ratios may be calculated based on data collected generally, from all recipes and audiences, or may be calculated for various sub-categories including, without limitation, geographic origin, cuisine type, target market, such as vegans, foodies, and children, other, like, sub-categories, and any combination thereof. A first example of a calculated ratio may be a calculation indicating that the average ratio of salt to tomato is one to one hundred, or one gram of salt per one hundred grams of tomatoes. A second example of a calculated ratio may be a ratio indicating that, in Spain, the average salt to tomato ratio is one to ninety-seven, where a third example may be a ratio indicating that, when a dish includes meat, the salt to tomato ratio is one to one-hundred-ten. An additional example of a calculated ratio may be a ratio indicating that, for recipes with rankings above seventy-eight percent, the average salt to tomato ratio is one to seventy-seven.

Where analysis at S340 includes analysis and calculation of ingredient and flavor ratios, the analysis at S340 may further include the calculation of ratios of total aggregated flavors and combinations of ingredients and flavors within dishes and recipes, based on flavor profiles and recipe-specified ingredient quantities. As an example, a ratio of flavors in a recipe may be calculated to indicate a flavor ratio of sweetness to bitterness to woodiness to fattiness to greenness to freshness of three to six to nineteen to twenty to sixty-seven to eight. Further, as may be applicable to the calculation of ratios of both ingredients and flavors, ratios may be calculated by recipe analysis. Where the calculation of a ratio of A to B is required, calculation may begin with the analysis of recipes containing only A and B. Following the analysis of recipes containing only A and B, calculation may further include tracking of recipes including minimal numbers of ingredients and determination of how the addition of other ingredients to A and B change the ratios previously identified. Subsequently, calculation may include tracking various patterns concerning increasing or decreasing the A to B ratio and learning relevant pattern rules. As an example of an A to B ratio pattern calculated as described, a pattern may indicate that, when adding twenty grams of ingredient C to an eighty-gram blend of A and B, the ratio between A and B rises ten percent.

Analysis at S340 may also include the generation of ingredient quantity suggestions. Ingredient quantity suggestions may be based on ingredient or flavor ratios, determined as described above, and may be applicable to the suggestion or recommendation of recipe variations during flavoring adjustment, as described at S360, below. The generation of ingredient quantity suggestions, during analysis at S340, may include collecting, from a user, a list of ingredients which the user would like to combine in a dish, and the generation of specific suggested quantities or ratios. The generation of ingredient quantity suggestions may include the generation of quantity suggestions at various levels of generality such as, as examples and without limitation, general suggestions derived from all recipes analyzed, focused suggestions based on further criteria related to geographic origin, cuisine type, target market, and other, like, factors, personalized suggestions based on user preferences, other, like, suggestions, and any combination thereof. As an example, an ingredient quantity suggestion, focused based on relevant criteria, may be a suggestion concerning quantities of tomato, black pepper, and basil for a four-hundred gram pasta dish, where the target for the dish is children in Brazil.

Analysis at S340 may further include ingredient intensity analysis. Ingredient intensity analysis may include calculation and description of the relative intensity of every ingredient in a given recipe, as may be achieved by analysis of ingredients' quantity ratios with respect to other ingredients and, in the aggregate, analysis of quantity ratios with respect to ratios and patterns learned from recipes, as described previously. Ingredient intensity may be calculated in general, based on all recipes and datapoints, or may be calculated in a focused manner, with respect to criteria including, without limitation, geographic origin, cuisine type, target market, and the like. As an example, ingredient intensity analysis may include generation of an analysis output specifying that, for users in Spain, the black pepper to tomato ratio in a given recipe is one to one-hundred-twenty while, in other recipes, for users in Spain, the black pepper to tomato ratio is between one to eighty-seven and one to two-hundred-three. Further, for the same example, ingredient intensity analysis may include a calculation that the relative intensity of pepper in the given recipe is below average and is three out of ten.

Further, where analysis at S340 includes ingredient intensity analysis, ingredient intensity analysis may also include analysis of data collected from users, describing the perceived intensity of ingredients. A perceived intensity description, as may be collected from user experience data as described at S320, above, may include reviews from users specifying that a recipe includes too much dill, in combination with a recipe author's description of the recipe as being for “pasta with extra cream.” Based on the results of ingredient intensity analyses, the analysis at S340 may include the evaluation of the intensity calculation process and, as needed, a calibration of the calculation process. A first example of an ingredient intensity analysis based on collected user data may be an analysis indicating that, when a significant number of users indicate that the intensity of black pepper in a recipe is five out of ten and not three out of ten, the ingredient intensity calculation should be re-calibrated by cross-analyzing black pepper with all other ingredients in the recipe. A second example of an ingredient intensity analysis may be an analysis indicating that the ingredient intensity calculation should accommodate a higher-than-expected amount of cream for a “pasta with extra cream” dish, and avoid considering the additional cream during normal statistical calculations.

In addition, analysis at S340 may include analysis of flavor balancing and intensity, whereby the flavor profile of a recipe is analyzed according to a list of basic flavors, such as bitter, sweet, woody, fatty, and the like, as well as relevant flavor balancing and intensity. Where analysis at S340 includes analysis of flavor balancing and intensity, the true or expected flavors of an ingredient, food, recipe, or dish may be determined by analysis of information from sources including, without limitation, flavor molecule data, flavor perception data, other, like, sources, and any combination thereof. The flavors of an ingredient and, in particular, the relevant flavor molecules and chemistry, may be appreciated in greater detail with respect to FIGS. 4A and 4B, below.

Where analysis at S340 includes analysis of flavor balancing and intensity, the analysis of flavor balancing and intensity may further include calculation of perceived flavors of a recipe according to the included flavor molecules. The calculation of perceived flavors of a recipe may indicate the opinions of one or more users regarding the perceived flavors of food ingredients, as well as the calculated perceived flavors of the same ingredient. By a process similar to that used to determine flavor based on molecular data, as described previously, analysis may include aggregation of ingredients' perceived flavors into accumulated flavors for a given recipe. The calculation of perceived flavors may include, without limitation, the determination of ingredients and their relevant quantities for a recipe, determination of a list of flavor molecules for each ingredient, determination of the chemical weight of every flavor molecule, determination of the flavors of every flavor molecule, calculation of the accumulated flavors of each ingredient, according to those calculations described with respect to FIG. 4B, below, and aggregation of the ingredients' relative flavors and calculation of an accumulated flavors fix intensity for the given recipe. The accumulated flavors fix intensity refers to the combined absolute flavor intensity of each dish, recipe or food, as determined based on the absolute flavor intensities of the various component ingredients or food molecules. Flavor fix intensity differs from relative flavor intensity, as described below, in that flavor fix intensity refers to an accumulated absolute flavor intensity, while relative flavor intensity refers to a flavor intensity adjusted to reflect the intensity of a flavor within a food, flavor molecule, ingredient, or dish, with respect to the maximum possible intensity of such a flavor, as described below.

Where analysis at S340 includes analysis of flavor balancing and intensity, analysis at S340 may further include evaluation of perceived flavors, whereby the perceived flavors of an ingredient or recipe may be estimated or evaluated based on the included flavor molecules. Evaluation of perceived flavors during analysis at S340 may include identifying patterns concerning how flavor molecules define perceived flavor. Based on the patterns identified, the analysis at S340 may be refined to include rules defining the translation of flavor molecule concentrations into perceived flavors. As an example, evaluating perceived flavors may include identifying which set of flavor molecules, as well as molecules other than flavor molecules, create a waxy flavor and, subsequently, labeling every ingredient containing the same set of flavor molecules and non-flavor molecules with the a label indicating a waxy flavor.

Further, where analysis at S340 includes analysis of flavor balancing and intensity, analysis at S340 may include flavor intensity calculation. Flavor intensity calculation may be directed to the calculation of the relative intensities of each flavor in a recipe, based on the recipe's flavor profile and flavors' fix intensity, determined as described above. The relative intensities of the flavors may be determined by comparing the determined fix intensity with the flavor intensity values found in other recipes and ingredient combinations. As an example of the determination of relative flavor intensities, the relative intensity of “sweetness” in a flavor molecule, ingredient, food, dish, or recipe may be determined by comparing a calculated fix sweetness value of 1,980 with the maximum of a range describing a normal sweetness scale, which may be, as an example, 2,090, leading to a determined relative sweetness of 1.980 divided by 2.090, or 0.947. Flavor intensity calculation may include analysis of data including, without limitation, source and recipe rankings, wherein examples associated with lower-ranked sources and recipes may be afforded reduced weight in the flavor intensity calculation. Further, flavor intensity calculation may include analysis of data including, without limitation, a recipe's geographic origin, a recipe's cuisine type, and a recipe's target market, such as vegans, foodies, children, and the like. As an example, a flavor intensity calculation may include a determination that, as the sweetness intensity of a pasta recipe from Italy is determined to be 3120, while, for other pasta recipes from Italy, the sweetness intensity is between 987 and 8903, the statistical sweetness intensity for the given recipe is two and six-tenths out of ten.

Where analysis at S340 includes analysis of flavor balancing and intensity, analysis at S340 may further include flavor balancing calculations. Flavor balancing calculations may be directed to the determination of relative flavor balancing, based on the calculated flavors' fix intensity and the balancing ratios between respective flavors. Relative flavor balancing may be determined by comparison of the calculated balancing between two flavors in a given recipe with the balancing of the same flavors applied to other recipes. Relative flavor balancing may include analysis of data including, without limitation, source and recipe ranking, wherein examples associated with lower-ranked recipes or sources may be afforded reduced weight in the relative flavor balancing calculation. Relative flavor balancing may further include analysis of data including, without limitation, a recipe's geographic origin, a recipe's cuisine type, and a recipe's target market, such as children, foodies, vegans, and the like. As an example, a relative flavor balancing calculation may include a determination that, as the sweet to sour balance of a first tomato soup for children is calculated to be one to twelve, while other tomato soups for children include sweet to sour balances of one-to-one through one-to-thirteen, the statistical balancing of sweet to sour in the first recipe is off-balance compared with the average tomato soup, and is situated at the top level of sweet to sour balances, reaching the ninety-eight percent level.

Analysis at S340 may further include recipe modification and ingredient substitution analysis, including persistent re-calibration of the analysis at S340 to learn ingredients which may be substituted into recipes while preserving the overall culinary experience. Recipe modification and ingredient substitution analysis, as may be included in the analysis at S340, may include revision of the analysis process to include substitute ingredients based on factors including, without limitation, data concerning which pairs of ingredients have been previously-identified as suitable replacements for one another in recipes defined as similar, such as by name, flavor profiles, user reviews, and the like. As an example, a pair-replacement analysis may indicate that tomatoes and cherry tomatoes are used in two recipes with identical names, and that the identically-named recipes include other, identical ingredients. Further, recipe modifications and ingredient substitutions may be based on data concerning which ingredients have similar flavor profiles, other data similar to that described, and any combination thereof.

Where analysis at S340 includes recipe modification and ingredient substitution analysis, the analysis may include identification of multiple pairs of recipes indicating that two ingredients may be substituted one for the other and, where the flavor profiles of both ingredients are similar, the ingredients may be identified as a substituting pair. A substituting pair may include a rank for the pair, based on factors including, without limitation, the number of pairs of recipes used to identify the substituting pair, the similarity of the two ingredients, and the similarity profile of the two ingredients.

The similarity of two or more ingredients, as may be further relevant to the generation, development, or analysis of flavor profiles, may be determined by comparison of various attributes of the two or more ingredients including without limitation, ingredient names, ingredient types, growing regions, common example dishes, texture, consistency, other, like, attributes, and any combination thereof. In an embodiment, the similarity of two or more ingredients may be determined by generating vectors including one or more ingredient attributes, such as those noted previously, and determining the Euclidian distance between two or more generated ingredient vectors, where the Euclidian distance may serve as an indication of ingredient similarity or dissimilarity.

Recipe modification and ingredient substitution analysis may be applied to the identification of groups of ingredients suitable for replacing other ingredients or groups of ingredients. An example of group ingredient replacement may be the replacement of ingredient Z with ingredients X and Y. Further, determinations made during recipe modification and ingredient substitution analysis may be applied to refine the analysis at S340 to provide similar replacement and substitution analyses for additional ingredients, recipes, and users.

Analysis at S340 may further include user profiling, wherein collected user data, as described above, may be assessed and categorized to create a culinary profile indicating a user's preferences for specific flavors or ingredients or combinations of flavors and ingredients. Profiling, as may occur during analysis at S340, may include the generation and persistent revision of a user profile, where the user profile may be applicable to analytic predictions regarding a user's preference for a given flavor, ingredient, or combination thereof. A user profile may be generated and continuously updated, during analysis at S340, based on factors including, without limitation, ingredient preferences, flavor preferences, flavor intensity preferences, ingredient ratio preferences, and any combination thereof. Profiling, as may occur during analysis at S340, may be better appreciated with reference to the collection of user experience data at S320, above, and the associated descriptions of relevant user experience data.

Analysis at S340 may include clustering of users based on data collected at S320, users' profile data as may be otherwise collected, other, like, user data, and any combination thereof. Clustering of users during analysis at S340 may include creating user groups and dividing users into the groups, wherein groups may include users with similar culinary preferences. Further, groups created and populated during analysis at S340 may be configured such that users in different groups differ significantly in terms of culinary preference. As a first example of user clustering, clusters may be generated during analysis at S340 such that users in a first group prefer one-and-a-half to two grams of basil per one-hundred grams of mozzarella, such that users in a second group prefer four-to-five grams of basil per one-hundred grams of mozzarella, and such that users in a third group do not like the combination of basil and mozzarella at all. In a second example of user clustering, a group, “G,” may be generated and populated such that group “G” is the only group containing users who enjoy sweet fruits with ginger.

Analysis at S340 may include analyses of user behavior patterns. User behavior patterns may be analyzed at S340 using techniques including, without limitation, neural networks, various pattern recognition methodologies, other, like, techniques, and any combination thereof for predicting user culinary preferences based on information including, without limitation, data collected at S320, data collected at S330, other, like, data, and any combination thereof. Analysis of user behavior patterns at S340 may include division of collected data into parameters. As an example of division of collected data into parameters, collected data may be divided into datapoints indicating that a given user enjoys tomatoes, enjoys foods with sweetness levels of four-to-five, dislikes ginger with chocolate, and enjoys a flavor, ingredient, food, or dish included as sample number twelve in a taste sampling kit, such as the taste kit described with respect to S320, above. Where the divided parameters indicate discernible patterns, analysis of user behavior patterns may include the generation of one or more predictions for a given user's preference. Further, where analysis of user behavior patterns includes the generation of one or more preference predictions, the analysis may additionally include a determination of whether to suggest particular foods, ingredients, flavor capsules, recipes, and the like, where such suggestions are described with respect to S360, below. As an example, a preference prediction may specify that, as the user likes tomatoes and foods with sweetness levels of four to five, but does not like ginger with chocolate, the probability that the user will like a combination of vanilla ice cream with a chili level of seven or lower is sixty-seven percent.

Analysis at S340 may further include personalization of flavor experiences based on generated clusters and identified patterns. Flavor experiences may be personalized for users based on the behavior of users in the same clusters, wherein users in the same cluster have similar culinary profiles and, therefore, may prefer similar ingredients, food products, flavors and combinations, flavor capsules, and the like. Personalization of flavor experiences at S340 may include generation of personalized flavor experiences, providing personalized flavor experience to users, or both generating and providing personalized flavor experiences. Further, personalization of flavor experiences may include identifying and applying a specific user's preferred levels for various flavors, as well as preferred flavor combinations.

Generation of personalized flavor experiences, as may be included in analysis at S340, may include a personalization process. The personalization process may include collecting data for a given user, as is described with respect to S320, above, classifying users into one or more groups, as described with respect to user clustering, identifying the preferences of other users in one or more groups, and assessing the probability that the preferences of a given user and the preferences of the given user's group or groups are similar.

As described in greater detail with respect to S360, below, flavor experience personalization may include providing personalized suggestions to users. Providing personalized suggestions to users may include providing flavoring suggestions. Flavoring suggestions may be suggestions regarding the enrichment of recipes or ingredients with additional flavors matching user preferences, based on user preference patterns identified during analysis. Further, flavoring suggestions may include the generation of suggested ingredient combinations matching a given user's preferences. As examples, flavoring suggestions tailored to reshape a pasta recipe based on a user's preferences may include suggestions that a first user increase the quantity of basil used in a recipe from one cup to two cups, and a suggestion that a second user use the recipe-specified amount of basil, as well as two grams of dried garlic. In addition, flavoring suggestions may include recommendations for new flavoring capsules, or flavor-containing elements, and new food products which may interest a given user.

At S350, flavor information is provided. Flavoring information may be information concerning the known or expected flavors of a flavor molecule, ingredient, food, dish, recipe, food product or other, like, flavor experience. Flavoring information may be developed during the analysis at S340, above. Flavoring information may be provided through a user device, such as the user device, 220, of FIG. 2, above, and the like, and by any combination thereof.

Providing flavor information at S350 may include providing culinary services. Culinary services are services leveraging the culinary experience based, at least in part, on the analysis performed at S340. Culinary services may enable a user to understand the expected culinary experience of a given food, ingredient, or recipe. Culinary services may be configured to provide users with flavor information based on user-generated lists of combined ingredients, both generally, based on the ingredients, and personally, with respect to the user's tastes and preferences. Culinary services may be configured to provide for recipe analysis and related services based on the ingredients of a recipe, the flavors of foods or ingredients, or both. Ingredient analysis may include analyzing the food ingredients in a recipe, as well as the quantities and intensities of the ingredients. Food analysis may include breaking food ingredients into lists of basic flavors and analyzing recipes based on flavor combinations and balancing.

Flavor information, as may be provided at S350, may include culinary services directed to predicting and explaining the expected culinary experience of a food, ingredient, or recipe. Culinary services directed to predicting and explaining culinary experiences may include predictions and explanations of ingredient balancing and intensity, noting the relative intensities of each ingredient in a recipe, as well as quantity balancing information for two or more ingredients. Further, culinary services directed to predicting and explaining culinary experiences may include predictions and explanations regarding flavor variety and information, calculating the perceived flavors in a recipe, food, or ingredient, and the relevant flavor balances and intensities, and describing the calculated perceived flavors to one or more users. Culinary services directed to predicting and explaining culinary experiences may also include predictions and explanations of flavor, ingredient, food, and recipe synergy, providing information regarding whether a combination of ingredients, foods, and flavors provides a positive or negative culinary experience, including information based on a user's preferences or tastes. In addition, culinary services directed to predicting and explaining culinary experiences may include predictions and explanations of classification and similarity, whereby a recipe may be analyzed to indicate predicted similarities to certain types of recipes such as, as an example, “sweet Mexican appetizers,” or similar known recipes such as, as an example, a prediction that a recipe is “similar to pasta Bolognese.”

At S360, flavoring adjustments are provided. Flavoring adjustments may be suggestions or recommendations designed to improve a user's flavor experience. Flavoring adjustments may include the addition or removal of an ingredient from a recipe, changes to ingredients quantities, changes in the balance between two or more ingredients, suggestions of a beverage or additional food product to pair with a dish, and the like. Flavoring adjustments may be provided to the user through a variety of outputs including, without limitation, provision through a user device, such as the user device, 220, of FIG. 2, above, synchronization with a dispenser device, such as the dispenser device, 250, of FIG. 2, above, other, like, outputs, and any combination thereof.

Flavoring adjustments, as provided at S360, may include culinary services. As at S350, culinary services are services leveraging the culinary experience based, at least in part, on the analysis performed at S340. Culinary services may enable a user to automatically or semi-automatically reshape expected culinary experiences based on personal preferences. Culinary services pertaining to reshaping the culinary experience may include automatic adjustments, semi-automatic adjustments, and the like, as well as any combination thereof. Further, culinary services pertaining to reshaping the culinary experience may include balancing quantities of a given set of ingredients. As at S350, culinary services may be configured to provide for recipe analysis and related services based on the ingredients of a recipe, the flavors of foods or ingredients, or both. Ingredient analysis may include analyzing the food ingredients in a recipe, as well as the quantities and intensities of the ingredients. Food analysis may include breaking food ingredients into lists of basic flavors and analyzing recipes based on flavor combinations and balancing.

Flavoring adjustments, as may be provided at S360, may include culinary services providing for automatic adjustments to the culinary experience. Automatic adjustments may include shaping food ingredient intensity by balancing the quantity and intensity of each food ingredient to accommodate a user's tastes and preferences. Further, automatic adjustments may include shaping flavor intensity by adjusting the quantity and intensity of each ingredient in a dish to reach a desired flavor intensity, such as by, as an example and without limitation, adding honey to provide for additional sweetness intensity. In addition, automatic adjustments may include expanding lists of ingredients by adding new food ingredients to an original recipe to enrich overall flavors and create synergies between the included elements. Automatic adjustments may also include additional adjustments similar to those examples provided, as well as any combination thereof.

Flavoring adjustments, as may be provided at S360, may further include culinary services providing for semi-automatic adjustments to a recipe, whereby a user's input may be applied to adjust a recipe based on the user's preferences. Semi-automatic adjustments may include adjustments to food ingredient intensity, whereby a user's preferences for the intensities of every ingredient may be applied to determine the quantities of each ingredient needed to reach the specified ingredient intensity target. Further, semi-automatic adjustments may include adjustments to flavor intensity, whereby a user's preferences for flavor intensity may be applied to determine the ingredient quantities required to reach the specified flavor intensity target.

In addition, flavoring adjustments, as may be provided at S360, may include ingredient quantity balancing, whereby a user's specification of a list of ingredients used in preparing a dish may be applied to provide one or more suggestions for quantities of each ingredient. In an embodiment, ingredient quantity balancing may include providing a profile of the culinary experience expected for each ingredient or ingredient quantity suggested.

At the optional step S370, flavoring information is synchronized with a dispenser device. Synchronizing flavoring information with a dispenser device, as at the optional step S370, may include synchronizing, executing, or both synchronizing and executing one or more flavoring programs. Flavoring programs may be automatic or semi-automatic programs instructing a dispenser device as to the use of one or more flavor elements, such as flavoring capsules, as may be included in a dispenser device. Flavoring programs may be managed according to various configurations including, without limitation, local management, within a dispenser device, remote management, such as from an application included in a user device, from a central flavoring management system, or from an external system, such as a smart kitchen management system, as well as by any, like, management scheme or combination thereof. Flavoring programs may be stored, executed, or otherwise managed by a dispenser device, such as, as an example, the dispenser device, 250, of FIG. 2, above.

Flavoring programs may include one or more instructions directing the operation of a dispenser device with regard to a specified food, recipe, flavoring routine, or other flavor experience. Flavoring programs may direct the operation of a dispenser device by providing parameters including, without limitation, the capsules or flavor-containing elements indicated, whether each capsule or flavor-containing element is mandatory, the quantities to be dispensed from each capsule or flavor-containing element, usage timing instructions, specifying capsule or flavor-containing element dispensing time or order, hardware instructions directing dispensing actuator operations, such as by describing a motor direction, speed, or torque. Flavoring programs may further direct the operation of a dispenser device by providing parameters similar to those described, as well as by any combination thereof.

Flavoring programs may be generated according to various methods including, without limitation, automatic or algorithmic generation by a flavor management system, automatic recipe-based generation, manual user generation, other, like, methods, and any combination thereof. Where programs are generated automatically based on a recipe, the process instructions included in the recipe may be analyzed by a flavor management system and converted into flavoring programs directing a dispenser device to provide flavoring in accordance with the recipe. In generating automatic recipe-based flavoring programs, a flavor management system may select a single or set of capsules or flavor-containing elements equivalent to the flavoring requirements included in the recipe, may identify relevant quantities of each selected flavor, and may specify the necessary flavoring timing or sequence for each capsule or flavor-containing element. Where flavoring programs are generated manually by a user, user specification of necessary capsules or flavor-containing elements, dispensation amounts, and dispensation timing and sequences may be converted into flavoring programs as may be applicable to the operation of a dispenser device. Where flavoring programs are generated manually by a user, the capsules or flavor-containing elements, dispensation amounts, and dispensation timing and sequences may be collected from a user's input as entered into one or more user devices, including the user device, 220, of FIG. 2, above.

Where, at the optional step S370, synchronizing flavoring information with a dispenser device includes synchronizing, executing, or both synchronizing and executing one or more flavoring programs, execution of flavoring programs may be according to one or more execution schemes. In an example execution scheme, executing a flavoring program may include identifying and selecting capsules or flavor-containing elements to be dispensed, followed by evaluating whether the identified and selected capsules or flavor-containing elements are included in the dispenser device. Where a mandatory capsule or flavor-containing element is not included in the dispenser device, an alert may be generated and sent to the user such as by, as examples and without limitation, displaying an alert through a display, readout, or other feature of a dispenser device, displaying an alert through one or more user devices, otherwise displaying an alert, and any combination thereof. Further, where a non-mandatory capsule or flavor-containing element is selected and identified, the execution of the flavoring program may return to the selection and identification of a subsequent capsule or flavor-containing element.

After determining whether a selected and identified capsule or flavor-containing element is included in a dispenser device, the execution of a flavoring program, according to an example, may subsequently include dispensing the precise quantity of the contents of the capsule or flavor-containing element, using the internal measurement capabilities of the dispenser device and, if insufficient quantities are included in the selected capsule or flavor-containing element, alerting the user and the flavor management system, such as by those alerts discussed with respect to missing mandatory capsules or flavor-containing elements.

Following the dispensing of the contents of a capsule or flavor-containing element, as described, the flavoring program may further direct the dispenser device to pause for further instruction. Where the flavoring program directs the dispenser device for pause for further instruction, the pause direction may include a “wait” command, whereby the flavoring program instructs the dispenser device to wait until a capsule or flavor-containing element is replaced, and a “skip” command, whereby the flavoring program instructs the dispenser device to repeat the execution process for a subsequent capsule or flavor-containing element, beginning with the identification and selection of a capsule or flavor-containing element, as described.

FIG. 4A is an example illustration depicting a flavor molecule classification table 400, utilized to describe flavoring information according to various embodiments. “Flavor molecules” refers to one or more chemical agents included in foods or beverage which, by triggering chemical processes during eating and drinking, produce one or more olfactory or gustatory sensations. The organization of flavoring information provides for the identification and possible selection of desirable and undesirable flavors and flavor combinations, allowing for the optimization of food and beverage flavor experiences. The flavor molecule classification table 400 includes an identifier 410, allowing a user to recognize particular foods, beverages, or ingredients, and their associated flavor molecules, by the food, beverage, or ingredient's common name. Further, the flavor molecule classification table 400 may include a table size selector 420, allowing a user to increase or decrease the number of flavor molecule entries included in the table. The flavor molecule classification table 400 may further include one or more information categories including, without limitation, common names 430, molecule identifiers 440, flavor profiles 450, other, like, categories, and any combination thereof.

In an embodiment, the flavor molecule classification table 400 may be configured such that flavor molecule entries may be sorted in ascending or descending alphabetical or numeric order according to contents of the included information categories. Where the table 400 is configured to enable sorting, the table 400 may be sorted by interacting with one or more category buttons, such as by, as an example and without limitation, clicking the “Common Name” 430 header, as shown in the provided table 400.

The flavor molecule classification table 400 may include one or more flavor molecule common names 430. The flavor molecule common names 430 may be abbreviated chemical names or acronyms describing the composition and structure of a flavor molecule. For example, and without limitation, a flavor molecule common name 430 may be formatted as “1-Decanol,” wherein such a formatting provides information regarding the structure and composition of the molecule, where providing the chemical formula, C₁₀H₂₁OH fails to describe the molecular structure. In an embodiment, flavor molecule common names may include one or more alternate names such as, as examples with respect to “1-Decanol,” described previously, “decyl alcohol,” “capric alcohol,” “epal 10,” and the like.

The flavor molecule classification table 400 may include a molecule identifier 440 for one or more flavor molecule entries. The molecule identifier 440 may be a reference to a standardized database including a plurality of chemical compounds, as well as the compounds' associated properties. The molecule identifier 440 may provide an identifying value enabling selection of the molecule identified in one or more specific databases, including, without limitation, PubChem®, as shown in the example table 400, the Chemical Abstract Service® (CAS), ChemSpider®, and the like. Further, the molecule identifier 440 may include one or more identifiers corresponding to entries for the same molecule across various chemical databases or services. In an embodiment, the table 400 may be configured to include one or more molecule identifiers 440 as hyperlinks, providing connection to chemical database entries for given molecules upon activation of the hyperlink, such as by, as an example and without limitation, clicking the hyperlink with a mouse and cursor.

The flavor molecule classification table 400 may further include a flavor profile 450 corresponding to each flavor molecule entry. The flavor profiles 450 included in the table 400 may include one or more aspects of the flavor profile described in greater detail with respect to FIG. 4A, below. The flavor profile 450 may include one or more flavor descriptors such as, as examples and without limitation, green, fatty, melon, pear, seaweed, cucumber, and the like. The flavor profile 450 may include descriptors which reference various foods or ingredients, descriptors which describe taste or flavor without reference to other foods or ingredients, other, like, descriptors, and any combination thereof. The individual descriptors included in the flavor profile 450 of a given flavor molecule may be internally ordered, within the profile 450, according to concentration, intensity, alphabetically by name, or by other, like, attributes. The ordering of descriptors within a flavor profile 450 is described in greater detail with respect to FIG. 4B, below.

FIG. 4B is an illustration depicting a flavor profile 450, according to an embodiment. The depicted flavor profile 450 may include one or more flavor descriptors, 460-1 through 460-n, and one or more flavor intensities, 470-1 through 470-n, for a given food or ingredient. The flavor profile 450 may be configured to represent each flavor's intensity 470 relative to the flavor of the food, as depicted in the example profile 450. Where the profile 450 is configured to represent each flavor's intensity 470 relative to the flavor of the food, the individual flavor intensities, 470-1 through 470-n, may be fractional values, with the sum of all the flavor intensities 470 equal to one. In an embodiment, the flavor intensities 470 included in the profile 450 may be non-relative values, indicating the intensity of each flavor in the ingredient or food without reference to the flavor of the ingredient or food as a whole.

Where, as depicted, the profile 450 is configured to include flavor intensity 470 values as fractions of the overall intensity of a food or ingredient, the intensity 470 of each flavor may be determined based on the flavor intensities 470 of individual flavor molecules, as described with respect to FIG. 4A, above, relative to the composition of the food or ingredient. The flavor intensity 470 associated with a first flavor descriptor 460 may be calculated according to the following formula:

F₁=ΣF₁ᵢ

In the formula above, the intensity 470 of a first flavor, F₁, relative to the overall flavor of the food or ingredient, is determined as the sum of the relative intensities of the first flavor provided by the flavor molecules included in the food or ingredient, where the it^{th} flavor molecule's contribution to the overall intensity 470 of the first flavor within a food is expressed as F₁ᵢ. The i^{th} flavor molecule's contribution to the overall intensity of the first flavor within the food or ingredient is determined according to the following formula:

F₁ᵢ=(mᵢ/m_{f})*p₁

In the formula above, the i^{th} flavor molecule's contribution to the overall intensity of the first flavor, the contribution given as F₁ᵢ, is the quotient of the total mass of the i^{th} flavor molecule, mᵢ, divided by the mass of the ingredient or food, given as mf, multiplied by the proportional intensity, p₁, of the first flavor matching a descriptor 460. The proportional intensity, p₁, may be a fractional value expressing the intensity of the first flavor, as provided by the i^{th} flavor molecule, relative to the overall flavor provided by the i^{th} flavor molecule. The proportional intensity, p₁, may be determined by analyses including, without limitation, collection of a predetermined value from a chemical or flavor information database or system, analytic determination, such as through analysis of user taste descriptions with reference to known food, ingredient, and flavor molecule compositions, by other, like, analyses, or any combination thereof. In an embodiment, the i^{th} flavor molecule's contribution to the intensity of the first flavor, F₁ᵢ, may be determined according to the following formula:

F₁ᵢ=mᵢ/mₘ)*p₁

In the formula above, the i^{th} flavor molecule's contribution to the overall intensity of the first flavor, F₁ᵢ, is the quotient of the mass of the i^{th} flavor molecule in a food or ingredient, mᵢ, divided by the mass of all flavor molecules in the food or ingredient, mₘ, multiplied by the proportional intensity, p₁, of the first flavor matching a descriptor 460.

In an example, an ingredient, I-892, may include a plurality of flavor molecules, M₁ through Mₙ. The first flavor molecule, M₁, includes two flavors of equal intensity relative to one another, F₁ and F₂. In the example, the mass of the first flavor molecule, M₁, is given as 3,200 milligrams for each 100 grams of the ingredient, I-892, where ingredient I-892 includes, in every 100 grams, 25,340 milligrams of flavor molecules of any type. In the example, the first flavor molecule's contribution to the overall intensity of the first flavor, F₁, is determined as the quotient of the mass of the first flavor molecule, 3.2 grams, divided by the overall mass of the ingredient, 100 grams, and multiplied by the proportional intensity of the first flavor in the first flavor molecule, 0.5, yielding a flavor intensity, relative to the total weight of the ingredient, of 0.016. The overall intensity of the first flavor in the ingredient is subsequently determined by applying the same calculations to the remaining flavor molecules and summing the first flavor intensity contributions of all the included flavor molecules.

Flavor profiles 450 may be applicable to the calculation of recipe flavors. Recipe flavors may be calculated by dividing a recipe into its basic ingredients and, based on the perceived or calculated flavors of each ingredient, calculating the flavor profile of the given recipe. The recipe flavor calculation process may include, without limitation, dividing a recipe into its basic ingredients, calculating the flavors of each ingredient, and aggregating the flavors of each ingredient to determine the unweighted contribution of each ingredient to the overall flavor. The aggregation of ingredient flavors may be achieved according to the following equation:

F₁=ΣF_{1.n}_{ᵢ}

In the above equation, the overall intensity of a first flavor, F₁, is determined as the sum of the contribution of each ingredient to the intensity of the first flavor. The contribution of each ingredient to the intensity of the first flavor is expressed as F_{1.n}_{ᵢ}, where nᵢ represents the i^{th} ingredient in the list of basic ingredients. When the aggregate intensity of each flavor is determined, the relative weight of each flavor within the dish or recipe may be calculated or determined, allowing the determination of an overall flavor profile for the dish or recipe. The relative weight of each flavor in a dish may be determined based on the combined weights of all flavor molecules contributing to each flavor, respectively, based on the combined weights of all ingredients contributing to each flavor, respectively, based on proportionally-scaled measures of flavor molecule and ingredient weights, based on the intensity of a particular flavor in a given flavor molecule or ingredient, based on other, like, measures, or based on any combination thereof.

FIG. 5 is an example schematic diagram of an analytic engine 230, which may be included in a system for designing food and beverage flavor experiences, according to an embodiment. The analytic engine 230 includes a processing circuitry 510 coupled to a memory 520, a storage 530, and a network interface 540. In an embodiment, the components of the system 500 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (CPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the analytic engine 230 to communicate with the various components, devices, and systems described herein for designing food and beverage flavor experiences, and for other, related, purposes.

It should be understood that the embodiments described herein are not limited to the specific architecture illustrated in FIG. 5, and that other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for designing food and beverage flavor experiences, comprising:
analyzing collected user experience data and collected flavor profile and recipe data;
determining flavoring information and flavoring adjustments based on the analysis; and
synchronizing the determined flavoring information and flavoring adjustments.

2. The method of claim 1, wherein user experience data includes at least one of: usage data, and taste data.

3. The method of claim 1, wherein flavor profile and recipe data includes at least one of: recipe information, taste and flavor data, food and ingredient chemistry data, flavoring rules, and nutritional information.

4. The method of claim 1, wherein the method is executed in response to a received flavoring request from a user of a dispensing device, and wherein the determined flavoring information and flavoring adjustments is synchronized with the dispensing device.

5. The method of claim 1, wherein analyzing collected user experience data and collected flavor profile and recipe data further comprises:
classifying the user experience data and collected flavor profile as at least one of: a flavor, a food, a dish, a culinary example, and a recipe.

6. The method of claim 5, wherein the culinary example is an example flavor experience, and wherein classifying the culinary example further comprises:
classifying the culinary example as at least one of: a positive classification, and a negative classification, based on at least one of: the perceptions of at least a user, and sensory data regarding the culinary example.

7. The method of claim 1, wherein analyzing collected user experience data and collected flavor profile and recipe data further comprises:
detecting at least one of: a flavor pattern, and an ingredient pattern.

8. The method of claim 7, wherein detecting, by applying a learning process, at least one of: a flavor pattern, or an ingredient pattern, further comprises:
creating a plurality of records, wherein each record of the plurality of records includes at least one of: general information, a description of a recipe's calculated flavor, an aggregation of ingredients' chemical structures, a calculated flavor, a perceived flavor, a nutritional value, an engineered feature of a recipe, an overall community ranking, an overall popularity ranking, source reliability information, a list of ingredients, an ingredient name, an ingredient quantity, a preparation method, and a chemical structure;
executing a learning process over the plurality of records to identify at least a pattern; and
assigning a score to each pattern learned.

9. The method of claim 1, wherein analyzing collected user experience data and collected flavor profile and recipe data further comprises:
analyzing and calculating an ingredient and flavor ratio for a set of two or more components, wherein the set of two or more components includes at least two of: an ingredient, a flavor, and a food.

10. The method of claim 9, wherein analyzing and calculating an ingredient and flavor ratio further comprises:
generating, for a set of two or more components, at least one of: an average, a median, and a standard deviation.

11. The method of claim 9, wherein analyzing collected user experience data and collected flavor profile and recipe data further comprises:
calculating a ratio of total aggregated flavors and combinations of ingredients and flavors within at least one of: a dish, and a recipe.

12. The method of claim 1, wherein analyzing collected user experience data and collected flavor profile and recipe data further comprises:
generating one or more personalized suggestions, wherein a personalized suggestion is an ingredient quantity suggestion.

13. The method of claim 1, wherein analyzing collected user experience data and collected flavor profile and recipe data further comprises:
calculating the relative intensity of each ingredient included in a recipe.

14. The method of claim 1, wherein analyzing collected user experience data and collected flavor profile and recipe data further comprises:
computing the perceived flavor of a recipe according to the flavor molecules included in the recipe;
wherein said computing the perceived flavor of a recipe according to the flavor molecules included in the recipe further comprises:
calculating the intensity of at least a perceived flavor included in the recipe; and
balancing the flavors within the recipe.

15. (canceled)

16. The method of claim 1, further comprising:
adjusting the analysis of collected user experience data and collected flavor profile and recipe data to learn one or more ingredients which may be substituted into one or more recipes without altering the culinary experience of the one or more recipes.

17. The method of claim 1, wherein analyzing collected user experience data and collected flavor profile and recipe data further comprises:
applying at least one of: a recipe modification analysis, and an ingredient substitution analysis to identify one or more replacement ingredients.

18. The method of claim 1, wherein analyzing collected user experience data and collected flavor profile and recipe data further comprises:
generating a culinary profile, wherein the culinary profile indicates a user's preferences for at least one of: a flavor, an ingredient, a combination of flavors, and a combination of ingredients.

19. The method of claim 1, wherein analyzing collected user experience data and collected flavor profile and recipe data further comprises:
clustering at least two users based on one or more of: collected user experience data, collected flavor profile and recipe data, and other collected user data;
wherein said clustering the at least two users further comprises:
personalizing a flavor experience based on at least a generated cluster and an analysis of at least a user behavior pattern.

20. (canceled).

21. A non-transitory computer readable medium having stored thereon instructions for causing a processing circuitry to execute a process, the process comprising:
analyzing collected user experience data and collected flavor profile and recipe data;
determining flavoring information and flavoring adjustments based on the analysis; and
synchronizing the determined flavoring information and flavoring adjustments.

22. A system for designing food and beverage flavor experiences, comprising:
a processing circuitry; and
a memory, the memory containing instructions that, when executed by the processing circuitry, configure the system to:
analyze collected user experience data and collected flavor profile and recipe data;
determine flavoring information and flavoring adjustments based on the analysis; and
synchronize the determined flavoring information and flavoring adjustments.
